(19) United States
(12) Patent Application Publication
(10) Pub. No.: US 2007/0193120 A1
(43) Pub. Date: Aug. 23, 2007

(54) Sealing gasket for the automobile industry or the contruction industry, for example

(76) Inventors: Bernard Tessier, Chalette Sur Loing (FR); Christophe Lebrize, Juranville (FR); Philippe Devaux, Lanureme (FR); Sylvain Andre, JB Colli (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/669,701

(22) Filed: Jan. 31, 2007

(30) Foreign Application Priority Data
Feb. 1, 2006 (FR) 06/00899

(51) Int. Cl. E06B 7/16

(52) U.S. Cl. 49/490.1

(57) ABSTRACT

A sealing gasket comprising at least one zone for putting into contact via a sealing barrier with a gasket-receiver support such as a rabbet on a frame surrounding a recess for a moving panel in the automobile industry or a contact zone between two stationary panels in the construction industry, wherein said sealing barrier comprises a rubber composition based on at least one thermoplastic elastomer of compact type presenting hardness on the Shore A scale, measured using the ASTM D 2240 standard, that is less than or equal to 40.

The invention relates to a sealing gasket in the automobile industry or the construction industry, for example, for the purpose in particular of avoiding leakage phenomena of the “siphoning” or “infiltration” type.

### BACKGROUND OF THE INVENTION

In general, in the automobile industry, for example, sealing gaskets are used that are secured by a portion of the gasket that forms a clamp, which clamp is fitted onto a rabbet, for example. Unfortunately, such gaskets are particularly exposed to siphon type ingress of water, e.g. whenever they constitute gaskets for tailgates, trunks, or moving rear quarter panels. More precisely, water runs along the outer perimeter of the gasket and manages to infiltrate via the web of the clamp into the vehicle cabin, the trunk, or the zone that is to be made leaktight, in particular at locations where the rabbet(s) present(s) variations in thickness or planeness.

To mitigate such ingress of water, it is known to have recourse to a sealing barrier such as a bead of highly deformable polyurethane foam as described in patent document U.S. Pat. No. 4,949,524, or more usually a bead or film of sealant as described in patent document FR-A 633 233 which is fastened against the web of the fastening clamp. Unfortunately, experience shows that having recourse to a polyurethane foam bead is not a long-lasting solution because of excessive permanent deformation after being subjected to compression, while having recourse to a bead or film of sealant leads specifically to problems of the rabbets being dirtied and/or polluted, which means that it is necessary to perform cleaning if a portion of the gasket happens to come off during assembly. Furthermore, during after-sales service, when it is necessary to replace a gasket and thus remove it completely from the rabbet, it becomes necessary to clean the mastic-dirtied rabbet using a solvent before putting a new gasket into place. Finally, a bead of sealant is very awkward to handle since it is viscous, sticky, and pollutes any element with which it comes into contact during finishing stages (chopper blade, cutter knife, drill bit, rivet, etc.).

### OBJECTS AND SUMMARY OF THE INVENTION

An object of the invention is to devise a novel type of sealing gasket that does not present the drawbacks of the prior art as mentioned above, while presenting other advantages and being suitable in particular for use in the automobile industry or in the construction industry.

To this end, the invention provides a sealing gasket comprising at least one zone for putting into contact via a sealing barrier with a gasket-receiver support such as a rabbet on a frame surrounding a recess for a moving panel in the automobile industry or a contact zone between two stationary panels in the construction industry, wherein said sealing barrier comprises a rubber composition based on at least one thermoplastic elastomer of compact type presenting hardness on the Shore A scale, measured using the ASTM D 2240 standard, that is less than or equal to 40.

It should be observed that the thermoplastic elastomer that is used for the sealing barrier is specifically of the compact type, and thus by definition is not of the rubber foam type (i.e. of the cellular type), unlike the above-mentioned foam beads of the prior art, thus making it possible in particular for the sealing barrier to present permanent deformation that is minimized after it has been subjected to compression.

Preferably, said thermoplastic elastomer presents hardness on the Shore A scale that is less than or equal to 20, and that is substantially equal to 0.

Also preferably, said thermoplastic elastomer may be a styrene thermoplastic elastomer, such as a styrene/ethylene/butylene/styrene (SEBS) block copolymer or a styrene/ethylene/propylene/styrene (SEPS) block copolymer, and the sealing barrier may be co-extruded on the zone of the gasket that is to be put into contact with the gasket-receiver support.

In general, the zone of the gasket that is to be put into contact with the gasket-receiver support may be based on a terpolymer of ethylene/propylene/diene monomer (EPDM) or on a thermoplastic elastomer (TPE), thermoplastic olefin (TPO), or thermoplastic vulcanizate (TPV) of the type comprising a mixture of a polyolefin and a rubber, such as EPDM, a material which is compatible with the material constituting the sealing barrier.

In an embodiment for the automobile industry, the gasket presents a fastener clamp forming a zone of the gasket that is to be put into contact with the gasket-receiver support such as a rabbet, said clamp being substantially of channel-section presenting a web and two lateral flanges, and in which said sealing barrier is fastened against the web of the clamp, e.g. having an arched shape, by a co-extrusion operation.

In another embodiment for the construction industry, the gasket is put into contact with a connection zone between two stationary panels via a sealing barrier deposited in the form of a bead or a film.

The material of the sealing barrier of the invention presents numerous advantages, of which the following can be mentioned in particular:

compatibility with materials such as EPDM and thermoplastic elastomers that can be used for making a support for receiving the material of the invention, with it being possible for these materials to be co-extruded;

the material is slightly sticky but non-polluting for production tools such as extruder screws, junction molds, or cutter tools; and

there is no phenomenon of the gasket-receiver support being polluted.

### BRIEF DESCRIPTION OF THE DRAWINGS

Other advantages, characteristics, and details of the invention appear from the additional description below made with reference to the accompanying drawing that is given purely by way of example, and in which:

FIG. 1 is a section view of a sealing gasket of the invention in the field of the automobile industry; and

FIG. 2 is a fragmentary perspective view of a sealing gasket of the invention in the construction industry.

### MORE DETAILED DESCRIPTION

The gasket 1 as shown in FIG. 2 is a gasket for use in the automobile industry, in particular for forming a gasket for a tailgate, trunk, or moving rear quarter panel.

The gasket 1 comprises a fastener portion 3 of generally channel-shaped section forming a clamp 5 that is designed to be fitted onto a rabbet 7. The gasket 1 also comprises a sealing portion 9 that is elastically deformable and that is shown in part only since it depends essentially on the type of gasket under consideration.

The invention relates in particular to providing sealing between the clamp 5 of the gasket 1 and the rabbet 7, i.e. at a portion of the gasket 1 that is subjected to penetration of water by siphoning, i.e. rainwater running along the outside perimeter of the gasket manages to infiltrate via the bottom of the clamp 5 into the vehicle cabin, the trunk, or the zone to be made leaktight, in particular at the locations where the rabbet 7 presents large variations in thickness or planeness.

More precisely, the clamp 5 of the gasket 1 presents a web 10 between two lateral flanges 12, possibly together with reinforcement 14 embedded in the clamp 5. In general, the clamp 5 can be made of a material based on a terpolymer of ethylene propylene diene monomer (EPDM) or a thermoplastic elastomer (TPE, TPO, or TPV) of the type comprising a mixture of a polyolefin and a rubber, such as an EPDM.

A sealing lining 15 is placed beside the web of the clamp 5 for the purpose of providing sealing relative to the rabbet 7 with which it comes into contact. This sealing lining 15 is a rubber composition based on at least one thermoplastic elastomer. The thermoplastic elastomer may be of the styrene type, and is advantageously a block copolymer of styrene/ethylene/butylene/styrene (SEBS) or a block copolymer of styrene/ethylene/propylene/styrene (SEPS), presenting hardness on the Shore A scale measured using the ASTM D 2240 standard, that is less than or equal to 40, preferably less than 20, and advantageously substantially equal to 0.

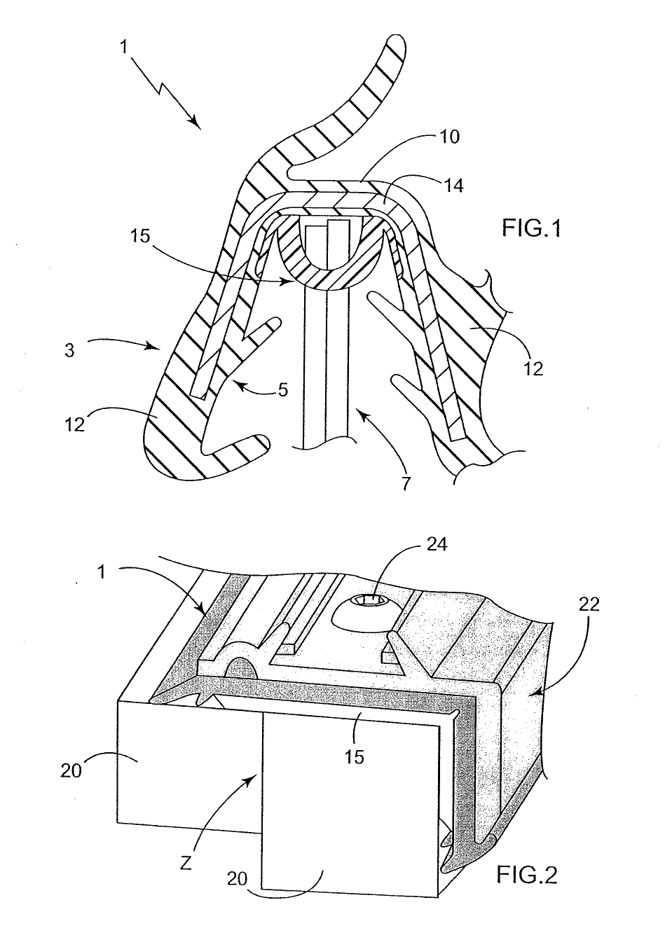

Such a sealing lining 15 is simultaneously flexible, slightly sticky, non-polluting, and soft, and in addition it is suitable for being co-extruded in the desired zone and with the desired shape. In the example shown in FIG. 1, the sealing lining 15 is of an arched shape, for example.

FIG. 2 shows another sealing gasket 1 for use in the building industry, for example, in order to provide sealing between two panels assembled one to the other, the assembly possibly presenting infiltration type leaks.

The two panels 20 are assembled one to the other by an assembly bracket 22 fastened to the outside of the two panels 20 by fastener means such as a screw 24, with a sealing gasket 1 being interposed that comes into contact with both panels 20 via a sealing barrier 15 of the above-specified type that is deposited in the form of a bead or a film so as to avoid nay infiltration of water from the outside via the contact zone Z between the two panels 20.

What is claimed is:

1. A sealing gasket comprising at least one zone for putting into contact via a sealing barrier with a gasket-receiver support such as a rabbet on a frame surrounding a recess for a moving panel in the automobile industry or a contact zone between two stationary panels in the construction industry, wherein said sealing barrier comprises a rubber composition based on at least one thermoplastic elastomer of compact type presenting hardness on the Shore A scale, measured using the ASTM D 2240 standard, that is less than or equal to 40.

2. A sealing gasket according to claim 1, in which said thermoplastic elastomer presents hardness on the Shore A scale less than or equal to 20.

3. A sealing gasket according to claim 2, in which said thermoplastic elastomer presents hardness on the Shore A scale that is substantially equal to 0.

4. A sealing gasket according to claim 1, in which said thermoplastic elastomer is a styrene thermoplastic elastomer.

5. A sealing gasket according to claim 4, in which said styrene thermoplastic elastomer is a styrene/ethylene/butylene/styrene (SEBS) block copolymer.

6. A sealing gasket according to claim 4, in which said styrene thermoplastic elastomer is a styrene/ethylene/propylene/styrene (SEPS) block copolymer.

7. A sealing gasket according to claim 1, in which the sealing barrier is co-extruded on the zone of the gasket that is to come into contact with the gasket-receiver support.

8. A sealing gasket according to claim 1, in which the zone of the gasket that is to come into contact with the gasket-receiver support is based on a terpolymer of ethylene/propylene/diene monomer (EPDM), or of a thermoplastic elastomer (TPE, TPO, or TPV) of the type comprising a mixture of a polyolefin and a rubber such as an EPDM.

9. A sealing gasket according to claim 1, in which the gasket presents a fastener clamp forming the zone of the gasket that is to be put into contact with the gasket-receiver support such as a rabbet, said clamp being substantially of channel-section presenting a web and two lateral flanges, and in which said sealing barrier is mounted adjacent the web of the clamp.

10. A sealing gasket according to claim 9, in which the sealing barrier is of arched shape.

11. A sealing gasket according to claim 1, in which the gasket is put into contact with a contact zone between two stationary panels via the sealing barrier that is deposited in the form of a bead or a film.
